(19) United States
(12) Patent Application Publication
(10) Pub. No.: US 2007/0126395 A1
(43) Pub. Date: Jun. 7, 2007

(54) Automatic recharging docking station for electric vehicles and hybrid vehicles

(76) Inventor: Michael J. Suchar, Forked River, NJ (US)

Correspondence Address: CLIFFORD G. FRAYNE, Suite 7A, 136 Drum Point Road, Brick, NJ, 08723, US

(21) Appl. No.: 11/599,554

(22) Filed: Nov. 15, 2006

Related U.S. Application Data
(60) Provisional application No. 60/740,761, filed on Dec. 1, 2005.

(51) Int. Cl. H02J 7/00

(52) U.S. Cl. 320/109

(57) ABSTRACT

An automatic recharging docking station for electric vehicles or hybrid electric vehicles in which standardized uniform charging stations are positioned in public parking facilities, private parking facilities, rest stops, or the like, and by means of a retractable vehicle probe, allow the owner/user of the vehicle to attach to the charging station and recharge the batteries or storage cells of the vehicle while the owner/user is at work, shopping, or otherwise not requiring the use of the vehicle. The particular vehicle and vehicle probe would have an encrypted identification means so that its identity would be recorded when it connected to a particular recharging station, regardless of which electrical jurisdiction that charging station was located, such that the respective electric utility companies or other entity would be able to identify and bill the owner/user for the quantity of electricity drawn during a specified time period.

### RELATED APPLICATIONS

This application claims the benefit of provisional application Ser. No. 60/740,761, filed Dec. 1, 2005.

### BACKGROUND OF THE INVENTION

1. Field of the Invention

The present invention relates to electric vehicles and hybrid vehicles utilizing a conventional internal combustion engine in tandem with an electric motor, and more particularly, to a charging station which could be positioned on public or private property and cooperative with a vehicle probe unit which would allow for the batteries or storage cells of the electric motor to be recharged while the user is not using the vehicle.

2. Description of the Prior Art

Concerns over rising pollution, global warming, and the cost of fuel, has led to a greater interest in the use of electric power for powering vehicles, either using electric power alone, or electric power in a hybrid vehicle which also includes a tandem internal combustion engine. The initial limitations on an electric vehicle were the charging capacity of the batteries so as to allow the vehicle to operate at comparable speeds with internal combustion engines and over comparable time periods. Technology advances in storage cell design have made electric vehicles a viable alternative to internal combustion engines, however, the ability to recharge the storage cell/batteries remains a major drawback to acceptance by the people of an electric vehicle. For instance, improved storage cells may give an electric vehicle a range of 100 miles at comparable speeds with internal combustion engines. This limits the user to a 50 mile radius from his home if he is a commuter, since he must make a return trip to his house in order to recharge the storage cells. The recharging typically involves a power cable connected between the vehicle and a charging station/electrical outlet located within the user's garage or dwelling. If charging stations were available in public or private locations, such as parking garages, rest stops, or private parking lots associated with a particular business, the electric vehicle could be recharged while in the parking space or parking lot while the owner/user is at work or shopping. The availability of such charging stations and the configuration of a charging probe on the electric vehicle would encourage electric vehicles because the potential buyers and users would know that they were not limited to a drive or commute that was set by the charge of the battery or storage cell, and also due to the convenience of the method in which the charging connection is established.

The ability/option to recharge a hybrid vehicle would provide the owner/operator a choice in fuel selection. The cost of a unit of electricity (kilowatt hour) is usually significantly more cost effective method of transportation than a similar unit of a fossil fuel, hydrogen, or alcohol base fuel.

### OBJECTS OF THE INVENTION

An object of the present invention is to provide for a novel charging station for the recharging of electric or hybrid vehicles which charging station would be located conveniently in public or private parking lots or in rest stops, and which would allow the owner/user to recharge the car while it was parked and not in use via a vehicle probe unit compatible with and cooperative with the charging station.

A still further object of the present invention is to provide for a novel charging station and cooperative vehicle probe in which the vehicle probe is encrypted so as to identify the vehicle and its owner and the owner's address so that the vehicle could be recharged at a variety of different charging stations in a variety of different electrical utility jurisdictions, but each electrical utility would be able to identify the owner/user and his or her location and the quantity of electricity drawn from any particular charging station for the purposes of billing.

A still further object of the present invention is to provide for a novel charging station for an electric vehicle or hybrid electric vehicle in which the charging stations are of a uniform and standardized height and the vehicle probe cooperable with the charging station is retractably positioned on the vehicle so as to be able to engage the charging station regardless of its locale.

A still further object of the present invention is not only to provide a storage cell/battery recharge, but also to provide a source of electric power to the vehicle. The vehicle would have the capability, while parked, to maintain current cabin temperature, preheat and precool the cabin during extended non-use periods, or other electrical functions.

### SUMMARY OF THE INVENTION

An automatic recharging docking station for electric vehicles or hybrid electric vehicles in which standardized uniform charging stations are positioned in public parking facilities, private parking facilities, rest stops, or the like, and by means of a retractable vehicle probe, allow the owner/user of the vehicle to attach to the charging station and recharge the batteries or storage cells of the vehicle while the owner/user is at work, shopping, or otherwise not requiring the use of the vehicle. The particular vehicle and vehicle probe would have an encrypted identification means so that its identity would be recorded when it connected to a particular recharging station, regardless of which electrical jurisdiction that charging station was located, such that the respective electric utility companies or other entity would be able to identify and bill the owner/user for the quantity of electricity drawn during a specified time period.

### BRIEF DESCRIPTION OF THE DRAWINGS

These and other objects of the present invention will become apparent, particularly when taken in light of the following illustrations wherein:

FIG. 1 is a side view of a typical installation;

FIG. 2 is a front view of the charging station; and

FIG. 3 is a schematic view of the operation of the system.

### DETAILED DESCRIPTION OF THE INVENTION

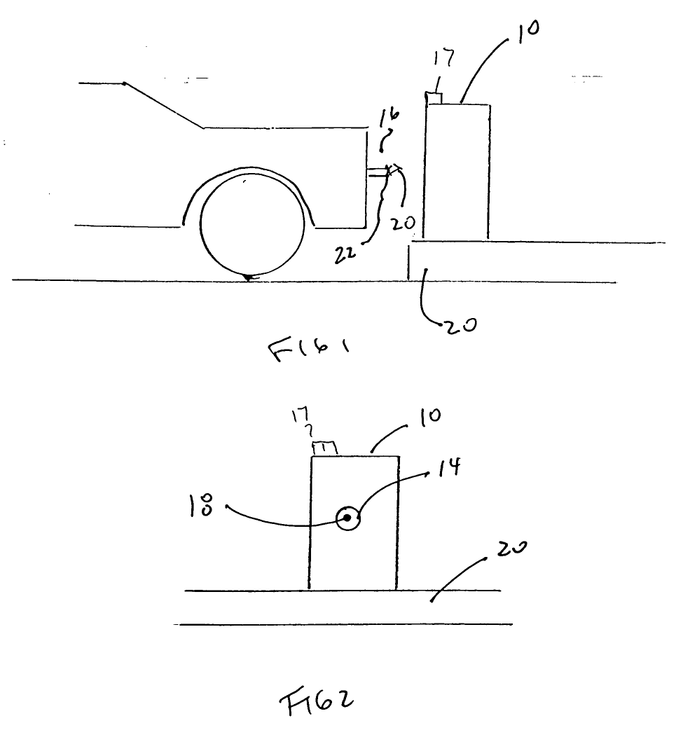

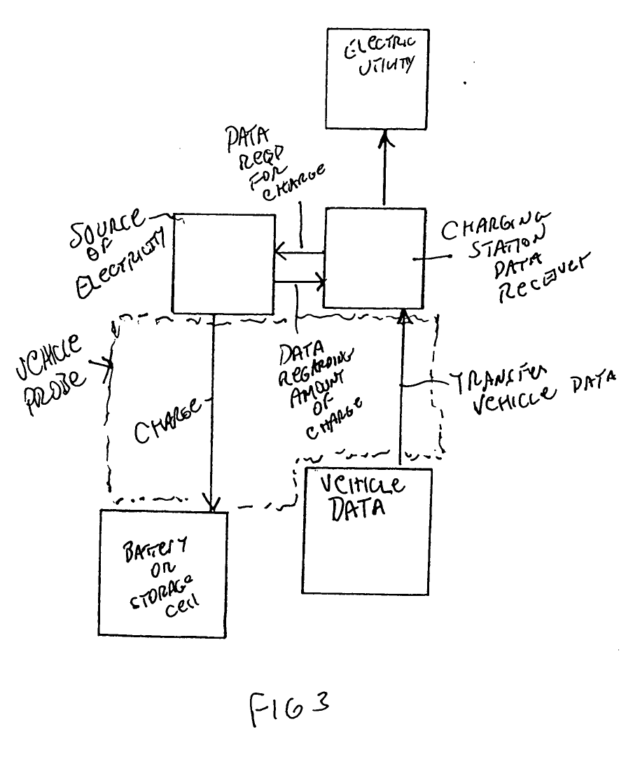

FIG. 1 is a side view of a charging station and a vehicle, and FIG. 2 is a front view of the charging station. The system comprises a terminal base charging station 10 located at the curb 12 or at the head of a parking space, the charging station comprises a parabolic cone alignment receptacle 14 for receipt of the vehicle probe 16 when extended. The probe is guided by the parabolic cone alignment receptacle design and connects with an electrical and data connection 18. The vehicle automatically sends information to the base unit via the data connection to synchronize the charge and to identify the owner/user of the vehicle and his address. This information is transmitted to the particular electrical utility providing electrical power in the particular jurisdiction in which the car is being recharged. The electric utility or other entity can then bill the owner/user for the electricity drawn on a monthly basis or other prescribed time basis. Alternatively, the electrical power can be purchased at the charging station 10 via a credit card swipe 17 mounted on the charging station 10 and billed to the credit card holder.

The electrical supply and data transmission cables for the base charging station are provided through the base of the unit. However, data transmission could be of a wireless nature. The nature of the parabolic cone alignment receptacle 14 and its design is such that the extended probe 16 self-aligns and guides the probe head into the charging position and data position. The entrance to the parabolic cone alignment receptacle 14 could be made weather resistant, such as but not limited to, by incorporating a wall of bristles or a drape of waterproof fabric, which would allow passage of the probe into the cone area. The height of the charging station and the height of the parabolic cone alignment receptacle could be standardized such that it accommodates a variety of different sized vehicles. It would appear that a height for the parabolic alignment cone 14 of approximately 24 inches would accommodate most vehicles since this height coincides with the majority of vehicles, grills or headlamp areas.

The data recognition unit would be of a design that would be able to determine, but not limited to the amount of type and charge required, the vehicle I.D., a calculation of the kilowatt hours used and a display of the cost of the kilowatt hours, and further calculate road use tax.

The vehicle probe 16 unit would be located at the front of the vehicle and would be activated by a typical instrument switch which would extend the probe in a telescopic manner towards the parabolic alignment cone or by an automatic sensor. A switchless design can be incorporated by which a wireless signal from the base station can automatically activate the connection sequence from the vehicle after positioned within the designated parking/charging area. Incorporated into the design would be a predetermined limiting force associated with the extension which force would maintain the probe 16 in a charging and data connection mode for the course of recharging. The head 20 of the probe would be mounted on a swivel universal joint 22 as it attaches to the telescopic section of the probe assembly in order to maintain the probe head in a neutral position of alignment as it enters the parabolic alignment cone in order to make contact with the power and data connections at the terminus of the parabolic alignment cone.

In this configuration, an owner/user having an electric car that has a limit of 100 miles per charge would be able to commute in a one way direction for 100 miles, park the vehicle in a public or private parking lot, and engage the vehicle with an adjacent charging station. A hybrid vehicle owner/operator would also have the option of battery/storage cell recharge to reduce their cost of transportation.

FIG. 3 is a schematic of the data transfer from the vehicle to the charging station and the utility. The charging station would automatically identify the vehicle, the amount of charge required, the type of charge required, and all other data information. The charging station would initiate through the vehicle probe a charge of the vehicle's batteries or storage cells until they were fully charged and then stop. This would all be accomplished while the owner/user was not requiring the use of the vehicle since he was at work or shopping or performing some other task that left the vehicle idle for a period of time. With this type of configuration, more individuals would be encouraged to purchase and operate electric vehicles because the territorial limitations imposed by the battery charge life would be extended. It is also anticipated that due to reduction of the percentage of battery/storage cell discharge, the time between battery/storage cell replacement will be extended.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. An automatic recharging docking station for electric vehicles or hybrid vehicles, said automatic recharging docking station comprising:
a vehicle probe extentibly secured to a vehicle, said vehicle probe in communication with a battery or fuel cell on said vehicle;
a docking station mounted proximate a parking space, said docking station having a receptacle for receipt and securing of said vehicle probe, said docking station in communication with a source of electrical power;
an identifying, billing indicia means secured to said docking station for receipt of an identifying indicia from a driver or vehicle to initiate the flow of electrical power to said battery or said fuel cell of said vehicle;
a sensor means on said battery, or said fuel cell, or said vehicle in communication with said docking station to sense a full battery charge or fuel cell charge and to interrupt said electrical power to said battery, fuel cell or vehicle upon sensing said charge;
means for disengaging said vehicle probe from said docking station; and
means for payment of electrical power transferred to said battery or said fuel cell of said vehicle.

2. The automatic recharging docking station in accordance with claim 1 wherein said identifying billing indicia comprises a credit card swipe I.D. mechanism mounted on said docking station to identify user and initiate said flow of electrical power.

3. The automatic recharging docking station in accordance with claim 1 wherein said identifying billing indicia means comprises a coded indicia associated with said vehicle or said vehicle probe, said coded indicia identified and read by said docking station to identify user and initiate said flow of electrical power.

4. The automatic recharging docking station in accordance with claim 1 wherein said vehicle probe is manually extendable from said vehicle to said docking station.

5. The automatic recharging docking station in accordance with claim 1 wherein said vehicle probe is automatically extendable from said vehicle to said docking station when said batteries or said fuel cells require electrical power.

6. The automatic recharging docking station in accordance with claim 1 wherein said means for disengaging said vehicle probe from said docking station is either manual or automatic.

7. The automatic recharging docking station in accordance with claim 1 wherein said means for payment of electrical power transfer to said battery or said fuel cell of said vehicle is by means of said credit card swipe or billing to said user/owner of said coded indicia.
